(19) United States
(12) Patent Application Publication
(10) Pub. No.: US 2012/0243280 A1
(43) Pub. Date: Sep. 27, 2012

(54) INVERTER FOR CONVERTING A DIRECT CURRENT VOLTAGE INTO AN ALTERNATING CURRENT VOLTAGE AND METHOD THEREOF

(76) Inventors: Yung-Hsiang Liu, Taipei City (TW); Kuo-Hsin Chu, Hsinchu County (TW); Hsu-Chin Wu, Tainan City (TW)

(21) Appl. No.: 13/187,436

(22) Filed: Jul. 20, 2011

(30) Foreign Application Priority Data
Mar. 21, 2011 (TW) 100109526

(51) Int. Cl. H02M 7/5387

(52) U.S. Cl. 363/132

(57) ABSTRACT

An inverter includes a first half period circuit, a second half period circuit, a first inductor, and a second inductor. A DC voltage source is used for providing a DC voltage. A loop of the first half period circuit and the first inductor is used for converting the DC voltage into a first half period of an AC voltage of an AC voltage source, and modulating a shape of the first half period of the AC voltage according to a second clock. A loop of the second half period circuit and the second inductor is used for converting the DC voltage into a second half period of the AC voltage, and modulating a shape of the second half period of the AC voltage according to a third clock.

### BACKGROUND OF THE INVENTION

1. Field of the Invention

The present invention is related to an inverter for converting a direct current (DC) voltage to an alternating current (AC) voltage and method thereof, and particularly to an inverter for converting a DC voltage to an AC voltage and method thereof whose current paths of a first half period are independent of current paths of a second half period.

2. Description of the Prior Art

An inverter for converting a DC voltage to an AC voltage is used for converting DC electrical energy to an AC voltage source. Please refer to FIG. 1. FIG. 1 is a diagram illustrating an H-bridge inverter 100 according to the prior art. The H-bridge inverter 100 includes two switches T1, T2, two modulation switches T3, T4, and two inductors L1, L2, where D1-D4 are parasitic diodes of the switches T1, T2, and the modulation switches T3, T4. The inductors L1, L2, the switch T1, the modulation switch T4, and the inductors L1, L2, the switch T2, the modulation switch T3 form switch pairs respectively to switch alternately. In FIG. 1, a DC voltage source 102 is used for providing a DC voltage VIN, and a stabilization capacitor C is used for stabilizing the DC voltage VIN.

The H-bridge inverter 100 converts the DC voltage VIN provided by the DC voltage source 102 to an AC voltage of an AC voltage source AC through the inductors L1, L2, the switch pair composed of the switch T1, the modulation switch T4, and the inductors L1, L2, and the switch pair composed of the switch T2, the modulation switch T3, and the inductors L1, L2. In a free-wheeling state, the H-bridge inverter 100 utilizes the parasitic diodes D1-D4 to maintain a DC current direction. Because the H-bridge inverter 100 utilizes the parasitic diodes D1-D4 to maintain the DC current direction in the free-wheeling state, and the modulation switches T3, T4 of the H-bridge inverter 100 may be turned on simultaneously to short each other due to mistaken operation, the H-bridge inverter 100 has poorer conversion efficiency and lower reliability.

### SUMMARY OF THE INVENTION

An embodiment provides an inverter for converting a DC voltage to an AC voltage. The inverter includes a first half period circuit, a second half period circuit, a first inductor, and a second inductor. The first half period circuit has a first terminal coupled to a first terminal of a DC voltage source, a second terminal for receiving a second clock, a third terminal, a fourth terminal coupled to a second terminal of an AC voltage source, a fifth terminal for receiving a first clock, and a sixth terminal coupled to a second terminal of the DC voltage source, where the first half period circuit is turned on according to the first clock during a first half period of the AC voltage source, converts the DC voltage provided by the DC voltage source to a first half period of an AC voltage provided by the AC voltage source, and modulates a shape of the first half period of the AC voltage according to the second clock. The second half period circuit has a first terminal coupled to the first terminal of the DC voltage source, a second terminal for receiving an inverse first clock, a third terminal coupled to the fourth terminal of the first half period circuit, a fourth terminal, a fifth terminal for receiving a third clock, and a sixth terminal coupled to the second terminal of the DC voltage source, where the second half period circuit is turned on according to the inverse first clock during a second half period of the AC voltage source, converts the DC voltage provided by the DC voltage source to a second half period of the AC voltage, and modulates a shape of the second half period of the AC voltage according to the third clock. The first inductor has a first terminal coupled to the third terminal of the first half period circuit, and a second terminal coupled to the first terminal of the AC voltage source, where the first inductor is used for reducing harmonics of an AC current of the AC voltage source. The second inductor has a first terminal coupled to the fourth terminal of the second half period circuit, and a second terminal coupled to the first terminal of the AC voltage source, where the second inductor is used for reducing the harmonics of the AC current of the AC voltage source. A first dead time exists between a first half period and a second half period of the first clock, and a second dead time exists between a first half period and a second half period of the inverse first clock, where the first dead time and the second dead time are used for preventing the first half period circuit and the second half period circuit from being turned on simultaneously, the second clock is turned off during turning-on of the second half period circuit, and the third clock is turned off during turning-on of the first half period circuit.

Another embodiment provides a method for converting a DC voltage to an AC voltage. The method includes providing a DC voltage; turning on a first half period switch of a first half period circuit according to a first clock, and turning off a second half period switch of a second half period circuit according to an inverse first clock; a first half period modulation switch of the first half period circuit modulating a shape of a first half period of an AC voltage according to a second clock; utilizing a first free-wheeling diode, the first half period switch, the AC voltage source, and a first inductor to form a loop for the first inductor to release electric energy when the first half period modulation switch is turned off according to the second clock; turning on a second half period switch of the second half period circuit according to the first clock, and turning off a first half period switch of the first half period circuit according to the inverse first clock; a second half period modulation switch of the second half period circuit modulating a shape of a second half period of the AC voltage according to a third clock; utilizing a second free-wheeling diode, the second half period switch, the AC voltage source, and a second inductor to form a loop for the second inductor to release electric energy when the second half period modulation switch is turned off according to the third clock. A first dead time exists between a first half period and a second half period of the first clock, and a second dead time exists between a first half period and a second half period of the inverse first clock, where the first dead time and the second dead time are used for preventing the first half period circuit and the second half period circuit from being turned on simultaneously, the second clock is turned off during turning-on of the second half period circuit, and the third clock is turned off during turning-on of the first half period circuit.

The present invention provides an inverter for converting a DC voltage to an AC voltage and method thereof. The inverter and the method utilize a first half period circuit and a second half period circuit of the inverter not turned on simultaneously to operate alternately according to a first clock and an inverse first clock, respectively for transmitting a DC voltage provided by a DC voltage source to an AC voltage source by a single direction current. In addition, a loading current path of the inverter during a first half period of the AC voltage source is independent of a loading current path of the inverter during a second half period of the AC voltage source. During a free-wheeling state of the first half period circuit, the first half period circuit utilizes a first free-wheeling diode, a first inductor, the AC voltage source, and a first half period switch to form a loop for the first inductor to release electric energy; during a free-wheeling state of the second half period circuit, the second half period circuit utilizes a second free-wheeling diode, a second inductor, the AC voltage source, and a second half period switch to form a loop for the second inductor to release electric energy. Compared to the prior art, the present invention does not utilize parasitic diodes of the first half period modulation switch and the second half period modulation switch to form the loading current paths of the free-wheeling states, and the loading current path of the inverter during the first half period of the AC voltage source is independent of the loading current path of the inverter during the second half period of the AC voltage source, so the present invention can prevent the first half period modulation switch and the second half period modulation switch from being attacked frequently by the loading currents of the free-wheeling state of the first half period circuit and the free-wheeling state of the second half period circuit, and prevent the first half period modulation switch and the second half period modulation switch from being turned on simultaneously due to mistake operation. In addition, the present invention can reduce conduction loss and switching loss by selecting proper switch materials and free-wheeling diode materials. Therefore, compared to the prior art, the present invention has better conversion efficiency and higher reliability.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an H-bridge inverter according to the prior art.

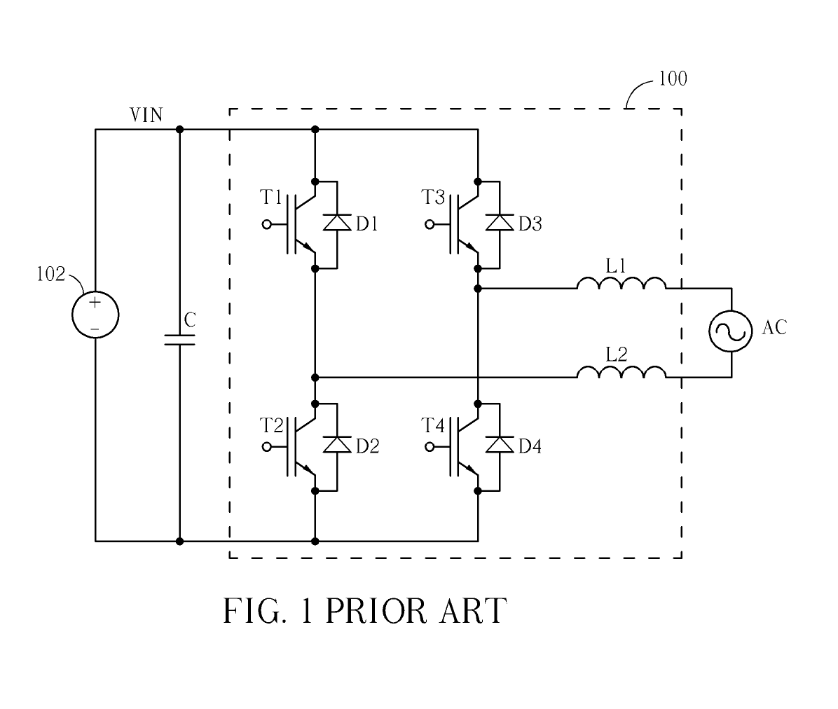

FIG. 2 is a diagram illustrating an inverter for converting a DC voltage to an AC voltage according to an embodiment.

FIG. 3A is a diagram illustrating a loading current path of the first half period circuit during the first half period of the AC voltage source.

FIG. 3B is a diagram illustrating a loading current path of the first half period circuit when the first half period modulation switch is turned off according to the second clock.

FIG. 4A is a diagram illustrating a loading current path of the second half period circuit during the second half period of the AC voltage source.

FIG. 4B is a diagram illustrating a loading current path of the second half period circuit when the second half period modulation switch is turned off according to the third clock.

FIG. 5 is a flowchart illustrating a method for converting a DC voltage to an AC voltage according to another embodiment.

### DETAILED DESCRIPTION

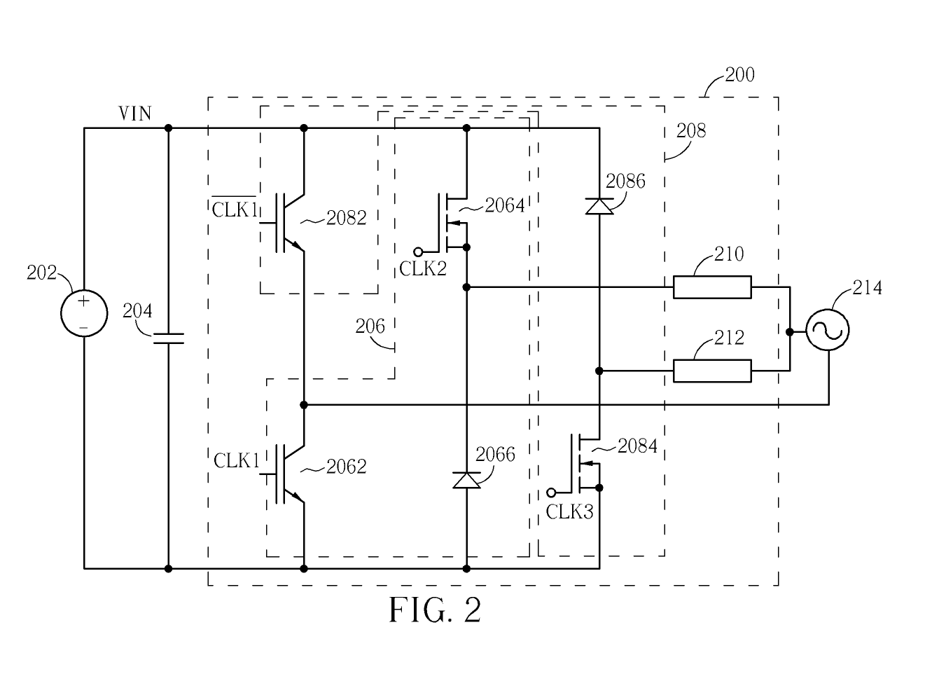

Please refer to FIG. 2. FIG. 2 is a diagram illustrating an inverter 200 for converting a DC voltage to an AC voltage according to an embodiment. The inverter 200 includes a first half period circuit 206, a second half period circuit 208, a first inductor 210, and a second inductor 212, where the first inductor 210 is the same as the second inductor 212. A DC voltage source 202 has a first terminal, and a second terminal, and the DC voltage source 202 is used for providing a DC voltage VIN. A stabilization capacitor 204 is coupled to the DC voltage source 202 for stabilizing and filtering the DC voltage VIN, where the stabilization capacitor 204 can include a capacitor or a plurality of capacitors. The capacitor or the plurality of capacitors forms a capacitor bank in a series form or a parallel form to shunt the DC voltage source 202. The first half period circuit 206 has a first terminal coupled to a first terminal of the DC voltage source 202, a second terminal, a third terminal, a fourth terminal coupled to a second terminal of an AC voltage source 214, a fifth terminal for receiving a first clock CLK1, and a sixth terminal coupled to the second terminal of the DC voltage source 202, where the second terminal of the first half period circuit 206 is used for receiving a second clock CLK2. The first half period circuit 206 is turned on according to the first clock CLK1 during a first half period (that is, a positive half period) of the AC voltage source 214, and modulates a shape of the first half period of the AC voltage source 214 according to the second clock CLK2, where the second clock CLK2 is a high frequency pulse-width modulation (PWM) clock. A frequency of the second clock CLK2 can be above one kilohertz (such as 20 kHz). But, the frequency of the second clock CLK2 should be chosen carefully. If the frequency of the second clock CLK2 is too high, switching noise and electromagnetic interference of the inverter 200 may be serious; if the frequency of the second clock CLK2 is too low, the inverter 200 needs an inductor 210 having larger inductance to reduce harmonics of an AC current of the AC voltage source 214, resulting in cost, weight, and volume of the inverter 200 being increased significantly. The second half period circuit 208 has a first terminal coupled to the first terminal of the DC voltage source 202, a second terminal for receiving an inverse first clock C̅L̅K̅1̅, a third terminal coupled to the fourth terminal of the first half period circuit 206, a fourth terminal, a fifth terminal for receiving a third clock CLK3, and a sixth terminal coupled to the second terminal of the DC voltage source 202. The second half period circuit 208 is turned on according to the inverse first clock C̅L̅K̅1̅ during a second half period (that is, a negative half period) of the AC voltage source 214, and modulates a shape of the second half period of the AC voltage source 214 according to the third clock CLK3, where a frequency of the first clock CLK1 and a frequency of the inverse first clock C̅L̅K̅1̅ are a frequency of the AC voltage source 214 (such as 60 Hz). In addition, the third clock CLK3 is a high frequency pulse-width modulation clock. A frequency of the third clock CLK3 can be also above one kilohertz (such as 20 kHz). But, the frequency of the third clock CLK3 should also be chosen carefully. The first inductor 210 has a first terminal coupled to the third terminal of the first half period circuit 206, and a second terminal coupled to a first terminal of the AC voltage source 214, where the first inductor 210 can pass a DC voltage of the first half period circuit 206, and reduce harmonics of an AC current of the AC voltage source 214. The second inductor 212 has a first terminal coupled to the fourth terminal of the second half period circuit 208, and a second terminal coupled to the first terminal of the AC voltage source 214, where the second inductor 212 can pass a DC voltage of the second half period circuit 208, and reduce the harmonics of the AC current of the AC voltage source 214. In addition, a first dead time exists between a first half period and a second half period of the first clock CLK1, and a second dead time exists between a first half period and a second half period of the inverse first clock C̅L̅K̅1̅, where the first dead time and the second dead time are used for preventing the first half period circuit 206 and the second half period circuit 208 from being turned on simultaneously. The second clock CLK2 is turned off during turning-on of the second half period circuit 208, and the third clock CLK3 is turned off during turning-on of the first half period circuit 206.

The first half period circuit 206 includes a first half period switch 2062, a first half period modulation switch 2064, and a first free-wheeling diode 2066. The first half period switch 2062 has a first terminal coupled to the fourth terminal of the first half period circuit 206, a second terminal coupled to the fifth terminal of the first half period circuit 206 for receiving the first clock CLK1, and a third terminal coupled to the sixth terminal of the first half period circuit 206. The first half period switch 2062 is turned on according to the first clock CLK1 during the first half period of the AC voltage source 214, and the first half period switch 2062 is an NPN-type insulated gate bipolar transistor (IGBT) with a low conduction voltage. But, the present invention is not limited to the insulated gate bipolar transistor. That is to say, the first half period switch 2062 can also be a metal-oxide-semiconductor field effect transistor. The first half period modulation switch 2064 has a first terminal coupled to the first terminal of the first half period circuit 206, a second terminal coupled to the second terminal of the first half period circuit 206 for receiving the second clock CLK2, and a third terminal coupled to the third terminal of the first half period circuit 206. The first half period modulation switch 2064 is used for modulating the shape of the first half period of the AC voltage source 214 according to the second clock CLK2, and the first half period modulation switch 2064 is an N-type metal-oxide-semiconductor field effect transistor with a low conduction resistance. But, the present invention is not limited to the metal-oxide-semiconductor field effect transistor. That is to say, the first half period modulation switch 2064 can also be an insulated gate bipolar transistor. The first free-wheeling diode 2066 has a first terminal coupled to the third terminal of the first half period circuit 206, and a second terminal coupled to the sixth terminal of the first half period circuit 206. The first free-wheeling diode 2066 is modulated to compensate the first half period modulation switch 2064 according to the second clock CLK2 during the first half period of the AC voltage source 214, and the first free-wheeling diode 2066 is a silicon carbide Schottky diode. But, the first free-wheeling diode 2066 is not limited to the silicon carbide Schottky diode. In addition, in the present invention, parasitic diodes of the first half period switch 2062 and the first half period modulation switch 2064 can be neglected.

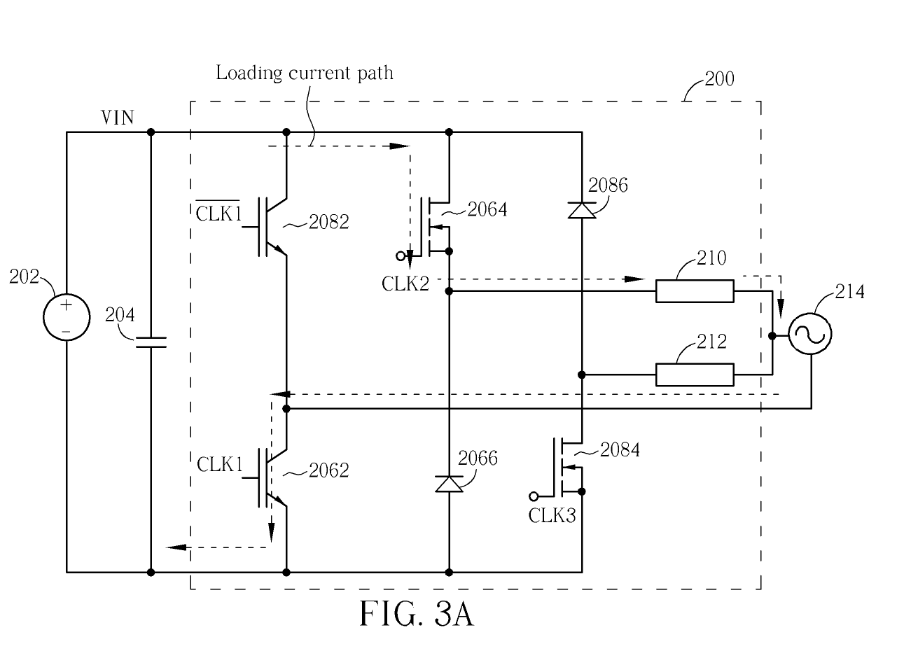

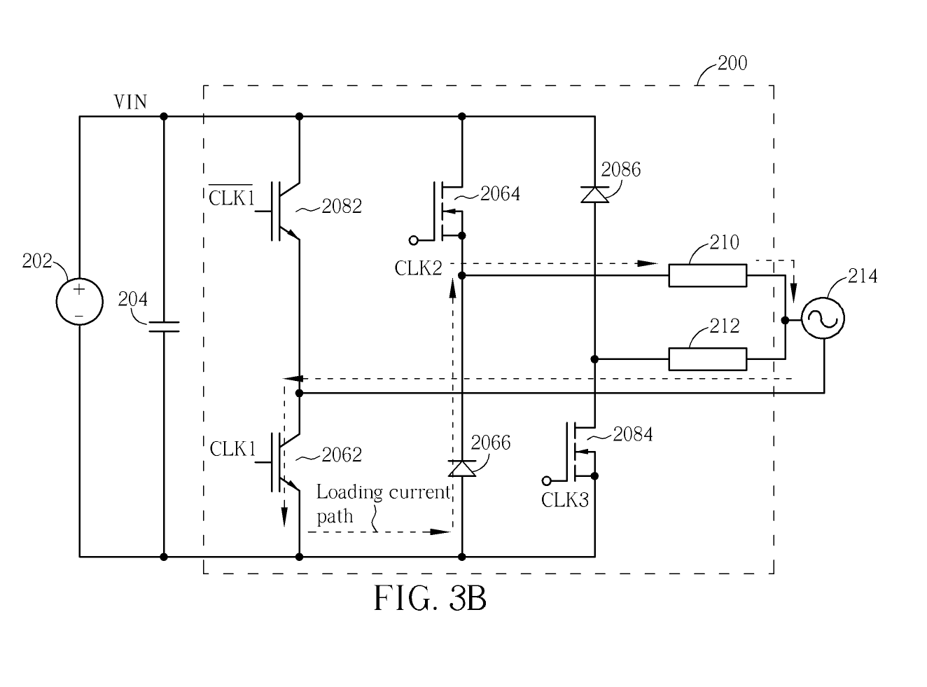

Please refer to FIG. 3A and FIG. 3B. FIG. 3A is a diagram illustrating a loading current path of the first half period circuit 206 during the first half period of the AC voltage source 214, and FIG. 3B is a diagram illustrating a loading current path of the first half period circuit 206 when the first half period modulation switch 2064 is turned off according to the second clock CLK2 (that is, in a free-wheeling state of the first half period circuit 206). As shown in FIG. 3A, when the first half period switch 2062 is turned on according to the first clock CLK1 during the first half period of the AC voltage source 214, the loading current flows from the first terminal of the first half period circuit 206 to the first half period modulation switch 2064, flows through the third terminal of the first half period circuit 206 and the inductor 210 to the AC voltage source 214, flows through the second terminal of the AC voltage source 214 and the fourth terminal of the first half period circuit 206 to the first half period switch 2062, and flows to the second terminal of the DC voltage source 202. As shown in FIG. 3B, when the first half period modulation switch 2064 is turned off according to the second clock CLK2, the first half period circuit 206 enters the free-wheeling state. The loading current flows from the third terminal of the first half period circuit 206 to the inductor 210, flows from the second terminal of the AC voltage source 214 to the fourth terminal of the first half period circuit 206, flows from the first half period switch 2062 to the sixth terminal of the first half period circuit 206, and flows from the first free-wheeling diode 2066 to the third terminal of the first half period circuit 206.

As shown in FIG. 2, the second half period circuit 208 includes a second half period switch 2082, a second half period modulation switch 2084, and a second free-wheeling diode 2086. The second half period switch 2082 has a first terminal coupled to the first terminal of the second half period circuit 208, a second terminal coupled to the second terminal of the second half period circuit 208 for receiving the inverse first clock C̅L̅K̅1̅, and a third terminal coupled to the third terminal of the second half period circuit 208. The second half period switch 2082 is turned on according to the inverse first clock C̅L̅K̅1̅ during the second half period of the AC voltage source 214, and the second half period switch 2082 is an NPN type insulated gate bipolar transistor with a low conduction voltage. But, the present invention is not limited to the insulated gate bipolar transistor. That is to say, the second half period switch 2082 can be also a metal-oxide-semiconductor field effect transistor. The second half period modulation switch 2084 has a first terminal coupled to the fourth terminal of the second half period circuit 208, a second terminal coupled to the fifth terminal of the second half period circuit 208 for receiving the third clock CLK3, and a third terminal coupled to the sixth terminal of the second half period circuit 208. The second half period modulation switch 2084 is used for modulating the shape of the second half period of the AC voltage source 214 according to the third clock CLK3, and the second half period modulation switch 2084 is an N-type metal-oxide-semiconductor field effect transistor with a low conduction resistance. But, the present invention is not limited to the metal-oxide-semiconductor field effect transistor. That is to say, the second half period modulation switch 2084 can also be an insulated gate bipolar transistor. The second free-wheeling diode 2086 has a first terminal coupled to the first terminal of the second half period circuit 208, and a second terminal coupled to the fourth terminal of the second half period circuit 208. The second free-wheeling diode 2086 is modulated to compensate the second half period modulation switch 2084 according to the third clock CLK3 during the second half period of the AC voltage source 214, and the second free-wheeling diode 2086 is a silicon carbide Schottky diode. But, the second free-wheeling diode 2086 is not limited to the silicon carbide Schottky diode. In addition, in the present invention, parasitic diodes of the second half period switch 2082 and the second half period modulation switch 2084 can be neglected.

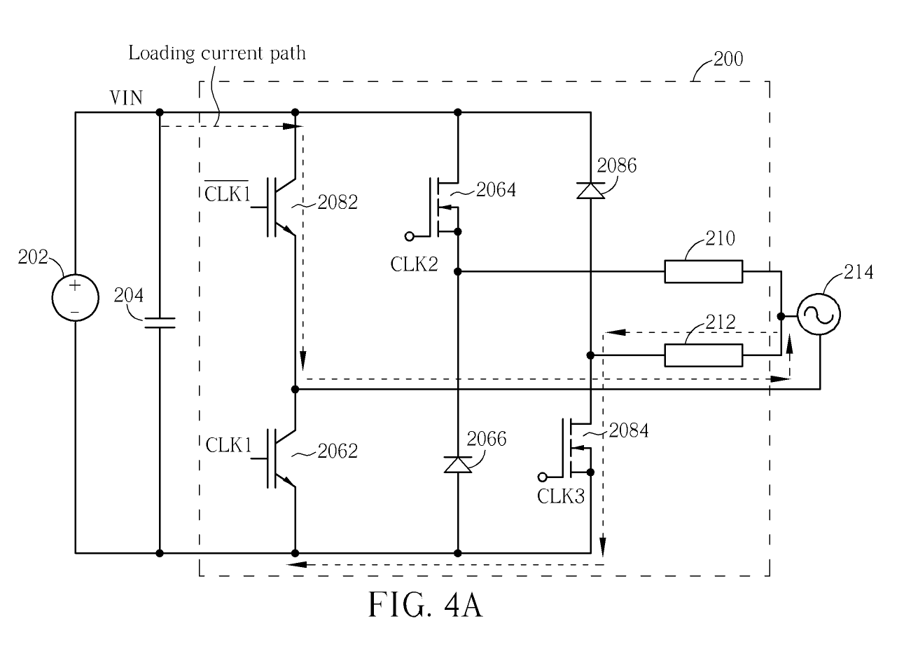

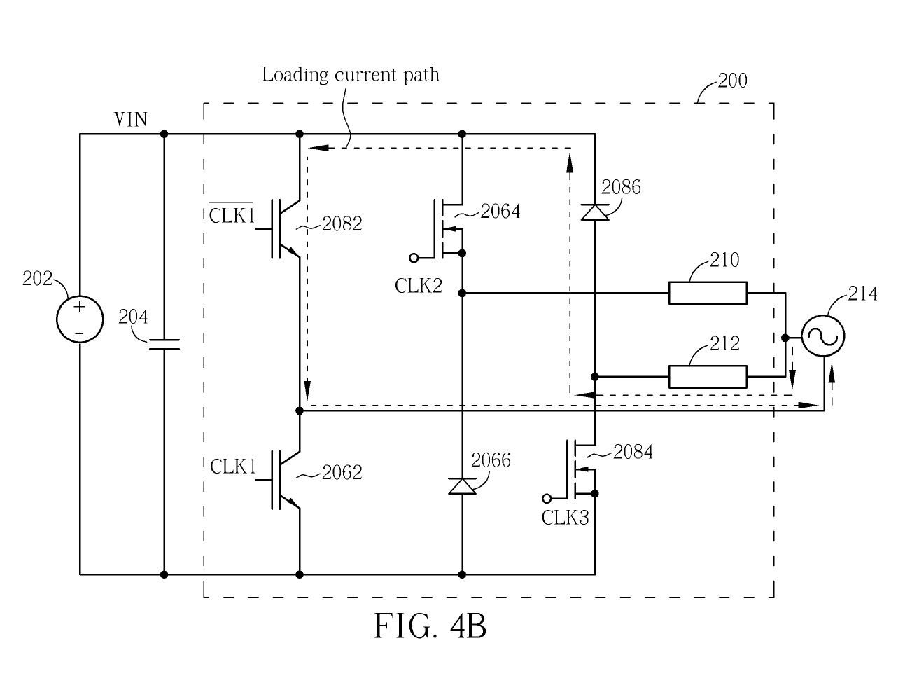

Please refer to FIG. 4A and FIG. 4B. FIG. 4A is a diagram illustrating a loading current path of the second half period circuit 208 during the second half period of the AC voltage source 214, and FIG. 4B is a diagram illustrating a loading current path of the second half period circuit 208 when the second half period modulation switch 2084 is turned off according to the third clock CLK3 (that is, during a free-wheeling state of the second half period circuit 208). As shown in FIG. 4A, when the second half period switch 2082 is turned on according to the inverse first clock C̅L̅K̅1̅ during the second half period of the AC voltage source 214, the loading current flows from the first terminal of the second half period circuit 208 to the second half period switch 2082, flows from the third terminal of the second half period circuit 208 to the second terminal of the AC voltage source 214, flows through the first terminal of the AC voltage source 214 and the second inductor 212 to the fourth terminal of the second half period circuit 208, and flows from the second half period modulation switch 2084 to the second terminal of the DC voltage source 202. As shown in FIG. 4B, when the second half period modulation switch 2084 is turned off according to the third clock CLK3, the second half period circuit 208 enters the free-wheeling state. Meanwhile, the loading current flows from the second inductor 212 to the fourth terminal of the second half period circuit 208, flows from the second free-wheeling diode 2086 to the first terminal of the second half period circuit 208, flows from the second half period switch 2082 to the third terminal of the second half period circuit 208, and flows from the second terminal of the AC voltage source 214 to the second inductor 212.

In addition, as shown in FIG. 2, the inverter 200 is an H-bridge circuit composed of the first half period circuit 206, the second half period circuit 208, the first inductor 210, and the second inductor 212.

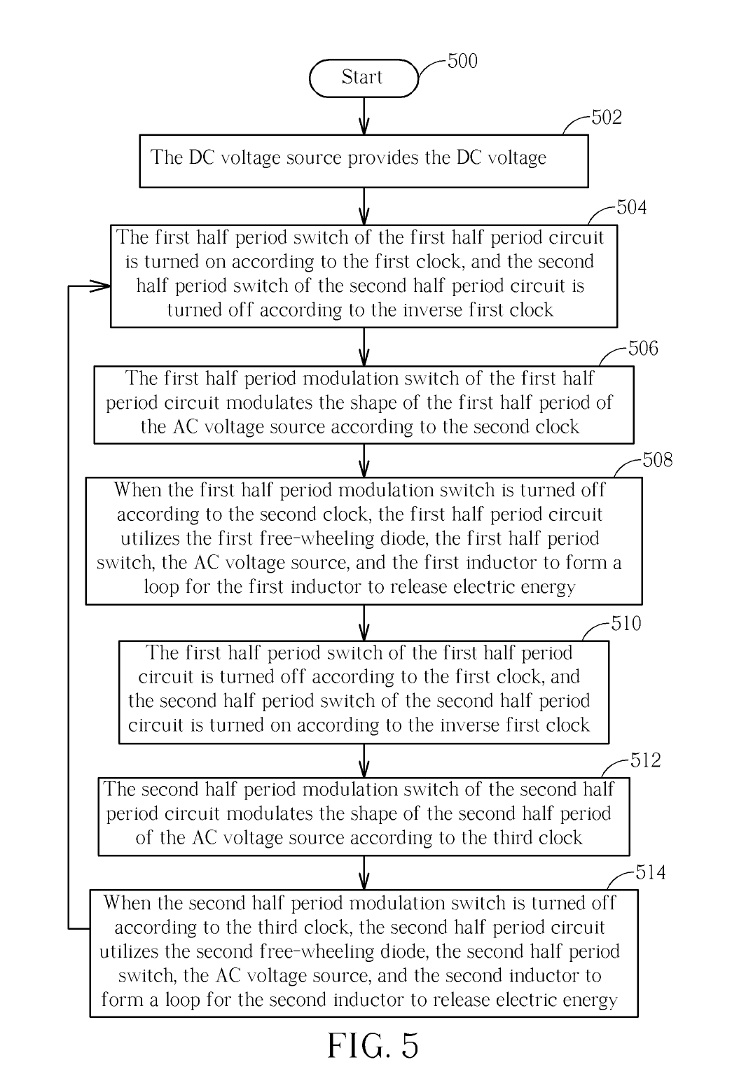

Please refer to FIG. 5. FIG. 5 is a flowchart illustrating a method for converting a DC voltage to an AC voltage according to another embodiment. The method in FIG. 5 uses the inverter 200 in FIG. 2 to illustrate the method. Detailed steps are as follows:

Step 500: Start.

Step 502: The DC voltage source 202 provides the DC voltage VIN.

Step 504: The first half period switch 2062 of the first half period circuit 206 is turned on according to the first clock CLK1, and the second half period switch 2082 of the second half period circuit 208 is turned off according to the inverse first clock C̅L̅K̅1̅.

Step 506: The first half period modulation switch 2064 of the first half period circuit 206 modulates the shape of the first half period of the AC voltage source 214 according to the second clock CLK2.

Step 508: When the first half period modulation switch 2064 is turned off according to the second clock CLK2, the first half period circuit 206 utilizes the first free-wheeling diode 2066, the first half period switch 2062, the AC voltage source 214, and the first inductor 210 to form a loop for the first inductor 210 to release electric energy.

Step 510: The first half period switch 2062 of the first half period circuit 206 is turned off according to the first clock CLK1, and the second half period switch 2082 of the second half period circuit 208 is turned on according to the inverse first clock C̅L̅K̅1̅.

Step 512: The second half period modulation switch 2084 of the second half period circuit 208 modulates the shape of the second half period of the AC voltage source 214 according to the third clock CLK3.

Step 514: When the second half period modulation switch 2084 is turned off according to the third clock CLK3, the second half period circuit 208 utilizes the second free-wheeling diode 2086, the second half period switch 2082, the AC voltage source 214, and the second inductor 212 to form a loop for the second inductor 212 to release electric energy; go to Step 504.

In Step 504, the frequency of the first clock CLK1 and the frequency of the inverse first clock C̅L̅K̅1̅ are the same as the frequency of the AC voltage source 214, where the first dead time exists between the first half period and the second half period of the first clock CLK1, and the second dead time exists between the first half period and the second half period of the inverse first clock C̅L̅K̅1̅. The first dead time and the second dead time are used for preventing the first half period circuit 206 and the second half period circuit 208 from being turned on simultaneously when the second clock CLK2 is turned off during turning-on of the second half period circuit 208, and the third clock CLK3 is turned off during turning-on of the first half period circuit 206. In addition, because the first half period switch 2062 is turned on and the second half period switch 2082 is turned off, only the first half period circuit 206 operates in the inverter 200. In Step 506, the first half period of the AC voltage source 214 is the positive half period of the AC voltage source 214. The first half period modulation switch 2064 of the first half period circuit 206 modulates the shape of the first half period of the AC voltage source 214 according to the second clock CLK2 for the shape of the first half period of the AC voltage source 214 to be smooth, where the second clock CLK2 is the high frequency pulse-width modulation clock. In Step 508, the first half period circuit 206 utilizes the first free-wheeling diode 2066, the first inductor 210, the AC voltage source 214, and the first inductor 210 to form the loop for the first inductor 210 to release the electric energy. In Step 510, because the first half period switch 2062 is turned off and the second half period switch 2082 is turned on, only the second half period circuit 208 operates in the inverter 200. In Step 512, the second half period of the AC voltage source 214 is the negative half period of the AC voltage source 214. The second half period modulation switch 2084 of the second half period circuit 208 modulates the shape of the second half period of the AC voltage source 214 according to the third clock CLK3 for the shape of the second half period of the AC voltage source 214 to be smooth. In Step 514, the second half period circuit 208 utilizes the second free-wheeling diode 2086, the second half period switch 2082, the AC voltage source 214, and the second inductor 212 to form the loop for the second inductor 212 to release the electric energy.

To sum up, the inverter for converting the DC voltage to the AC voltage and method thereof utilize the first half period circuit and the second half period circuit of the inverter not being turned on simultaneously to operate alternately according to the first clock and the inverse first clock, for respectively transmitting the DC voltage provided by the DC voltage source to the AC voltage source by a unidirectional current. In addition, the loading current path of the inverter during the first half period of the AC voltage source is independent of the loading current path of the inverter during the second half period of the AC voltage source. During the free-wheeling state of the first half period circuit, the first half period circuit utilizes the first free-wheeling diode, the first inductor, the AC voltage source, and the first half period switch to form the loop for the first inductor to release the electric energy; during the free-wheeling state of the second half period circuit, the second half period circuit utilizes the second free-wheeling diode, the second inductor, the AC voltage source, and the second half period switch to form the loop for the second inductor to release the electric energy. Compared to the prior art, the present invention does not utilize parasitic diodes of the first half period modulation switch and the second half period modulation switch to form the loading current paths of the free-wheeling states, and the loading current path of the inverter during the first half period of the AC voltage source is independent of the loading current path of the inverter during the second half period of the AC voltage source, so the present invention can prevent the first half period modulation switch and the second half period modulation switch from being attacked frequently by the loading currents of the free-wheeling state of the first half period circuit and the free-wheeling state of the second half period circuit, and prevent the first half period modulation switch and the second half period modulation switch from being turned on simultaneously due to mistaken operation. In addition, the present invention can reduce conduction loss and switching loss by selecting proper switch materials and free-wheeling diode materials. Therefore, compared to the prior art, the present invention has better conversion efficiency and higher reliability.

Those skilled in the art will readily observe that numerous modifications and alterations of the device and method may be made while retaining the teachings of the invention.

What is claimed is:

1. An inverter for converting a direct current voltage to an alternating current voltage, the inverter comprising:
a first half period circuit having a first terminal coupled to
a first terminal of a direct current (DC) voltage source, a second terminal for receiving a second clock, a third terminal, a fourth terminal coupled to a second terminal of an alternating current (AC) voltage source, a fifth terminal for receiving a first clock, and a sixth terminal coupled to a second terminal of the DC voltage source, wherein the first half period circuit is turned on according to the first clock during a first half period of the AC voltage source, converts the DC voltage provided by the DC voltage source to a first half period of an AC voltage provided by the AC voltage source, and modulates a shape of the first half period of the AC voltage according to the second clock;
a second half period circuit having a first terminal coupled to the first terminal of the DC voltage source, a second terminal for receiving an inverse first clock, a third terminal coupled to the fourth terminal of the first half period circuit, a fourth terminal, a fifth terminal for receiving a third clock, and a sixth terminal coupled to the second terminal of the DC voltage source, wherein the second half period circuit is turned on according to the inverse first clock during a second half period of the AC voltage source, converts the DC voltage provided by the DC voltage source to a second half period of the AC voltage, and modulates a shape of the second half period of the AC voltage according to the third clock;
a first inductor having a first terminal coupled to the third terminal of the first half period circuit, and a second terminal coupled to the first terminal of the AC voltage source, wherein the first inductor is used for reducing harmonics of an AC current of the AC voltage source; and
a second inductor having a first terminal coupled to the fourth terminal of the second half period circuit, and a second terminal coupled to the first terminal of the AC voltage source, wherein the second inductor is used for reducing the harmonics of the AC current of the AC voltage source;
wherein a first dead time exists between a first half period and a second half period of the first clock, and a second dead time exists between a first half period and a second half period of the inverse first clock, wherein the first dead time and the second dead time are used for preventing the first half period circuit and the second half period circuit from being turned on simultaneously, wherein the second clock is turned off during turning-on of the second half period circuit, and the third clock is turned off during turning-on of the first half period circuit.

2. The inverter of claim 1, wherein the first half period circuit comprises:
a first half period switch having a first terminal coupled to the fourth terminal of the first half period circuit, a second terminal coupled to the fifth terminal of the first half period circuit for receiving the first clock, and a third terminal coupled to the sixth terminal of the first half period circuit, wherein the first half period switch is turned on according to the first clock during the first half period of the AC voltage source;
a first half period modulation switch having a first terminal coupled to the first terminal of the first half period circuit, a second terminal coupled to the second terminal of the first half period circuit for receiving the second clock, and a third terminal coupled to the third terminal of the first half period circuit, wherein the first half period modulation switch is used for modulating the shape of the first half period of the AC voltage according to the second clock; and
a first free-wheeling diode having a first terminal coupled to the third terminal of the first half period circuit, and a second terminal coupled to the sixth terminal of the first half period circuit, wherein the first free-wheeling diode is used for being modulated to compensate the first half period modulation switch according to the second clock during the first half period of the AC voltage source.

3. The inverter of claim 2, wherein the first half period switch is an insulated gate bipolar transistor (IGBT).

4. The inverter of claim 2, wherein the first half period modulation switch is a metal-oxide-semiconductor field effect transistor.

5. The inverter of claim 2, wherein the first free-wheeling diode is a silicon carbide Schottky diode.

6. The inverter of claim 1, wherein the second half period circuit comprises:
a second half period switch having a first terminal coupled to the first terminal of the second half period circuit, a second terminal coupled to the second terminal of the second half period circuit for receiving the inverse first clock, and a third terminal coupled to the third terminal of the second half period circuit, wherein the second half period switch is turned on according to the inverse first clock during the first second period of the AC voltage source;
a second half period modulation switch having a first terminal coupled to the fourth terminal of the second half period circuit, a second terminal coupled to the fifth terminal of the second half period circuit for receiving the third clock, and a third terminal coupled to the sixth terminal of the second half period circuit, wherein the second half period modulation switch is used for modulating the shape of the second half period of the AC voltage according to the third clock; and
a second free-wheeling diode having a first terminal coupled to the first terminal of the second half period circuit, and a second terminal coupled to the fourth terminal of the second half period circuit, wherein the second free-wheeling diode is used for being modulated to compensate the second half period modulation switch according to the third clock during the second half period of the AC voltage source.

7. The inverter of claim 6, wherein the second half period switch is an insulated gate bipolar transistor.

8. The inverter of claim 6, wherein the second half period modulation switch is a metal-oxide-semiconductor field effect transistor.

9. The inverter of claim 6, wherein the second free-wheeling diode is a silicon carbide Schottky diode.

10. The inverter of claim 1, wherein the first half period of the AC voltage source is a positive half period of the AC voltage source and the second half period of the AC voltage source is a negative half period of the AC voltage source.

11. The inverter of claim 1, wherein a frequency of the first clock and a frequency of the inverse first clock are the same as a frequency of the AC voltage source.

12. The inverter of claim 1, wherein the second clock and the third clock are high frequency pulse-width modulation clocks.

13. The inverter of claim 1, wherein the first inductor is the same as the second inductor.

14. The inverter of claim 1, wherein the inverter is an H-bridge circuit.

15. A method for converting a DC voltage to an AC voltage, the method comprising:
providing a DC voltage;
turning on a first half period switch of a first half period circuit according to a first clock, and turning off a second half period switch of a second half period circuit according to an inverse first clock;
a first half period modulation switch of the first half period circuit modulating a shape of a first half period of an AC voltage according to a second clock;
utilizing a first free-wheeling diode, the first half period switch, the AC voltage source, and a first inductor to form a loop for the first inductor to release electric energy when the first half period modulation switch is turned off according to the second clock;
turning on a second half period switch of the second half period circuit according to the first clock, and turning off a first half period switch of the first half period circuit according to the inverse first clock;
a second half period modulation switch of the second half period circuit modulating a shape of a second half period of the AC voltage according to a third clock; and
utilizing a second free-wheeling diode, the second half period switch, the AC voltage source, and a second inductor to form a loop for the second inductor to release electric energy when the second half period modulation switch is turned off according to the third clock;
wherein a first dead time exists between a first half period and a second half period of the first clock, and a second dead time exists between a first half period and a second half period of the inverse first clock, wherein the first dead time and the second dead time are used for preventing the first half period circuit and the second half period circuit from being turned on simultaneously, wherein the second clock is turned off during turning-on of the second half period circuit, and the third clock is turned off during turning-on of the first half period circuit.

16. The method of claim 15, wherein the second clock and the third clock are high frequency pulse-width modulation clocks.

17. The method of claim 15, wherein a frequency of the first clock and a frequency of the inverse first clock are the same as a frequency of the AC voltage source.

18. The method of claim 15, wherein the first half period of the AC voltage source is a positive half period of the AC voltage source and the second half period of the AC voltage source is a negative half period of the AC voltage source.
